(19) United States
(12) Patent Application Publication
(10) Pub. No.: US 2024/0066937 A1
(43) Pub. Date: Feb. 29, 2024

(54) AIR SPRING ASSEMBLY FOR VEHICLE

(71) Applicant: ILJIN Co., Ltd., Gyeongju-si Gyeongsangbuk-do (KR)

(72) Inventors: Hwan Soo SONG, Seoul (KR); Ju Hyoung CHO, Seoul (KR)

(73) Assignee: ILJIN Co., Ltd., Gyeongju-si Gyeongsangbuk-do (KR)

(21) Appl. No.: 18/230,827

(22) Filed: Aug. 7, 2023

(30) Foreign Application Priority Data
Aug. 30, 2022 (KR) 10-2022-0108851

(51) Int. Cl. B60G 11/27

(52) U.S. Cl. CPC B60G 11/27

(57) ABSTRACT

An air spring assembly may include: a sleeve having a space capable of filling air therein and including upper and lower openings formed respectively in upper and lower portions of the sleeve; an upper cap connected to the upper portion of the sleeve so as to close the upper opening of the sleeve; a piston connected to the lower portion of the sleeve so as to close the lower opening of the sleeve; and a cylinder coupled to the sleeve so as to enclose the sleeve. A first fixing protrusion may be formed on at least a portion of an outer peripheral surface of the sleeve, a first fixing groove may be formed in at least a portion of an inner peripheral surface of the cylinder, and the first fixing projection may be inserted into and coupled to the first fixing groove.

### CROSS-REFERENCE TO RELATED APPLICATION

This application claims priority to Korean Patent Application No. 10-2022-0108851 filed on Aug. 30, 2022, the entire contents of which are herein incorporated by reference.

### TECHNICAL FIELD

The present disclosure relates to an air spring assembly for a vehicle.

### BACKGROUND

A suspension device for a vehicle is a device for connecting a vehicle shaft to a vehicle body so that vibration or impact transferred from a road surface when the vehicle travels on the road surface is prevent from being directly transferred to the vehicle body, thus preventing damage to the vehicle body or cargos and improving ride quality.

The suspension device for a vehicle is generally made of a spring, a damper, a suspension arm, and the like. As the spring of the suspension device, a coil spring, a leaf spring, a torsion bar, an air spring, or the like may be used. Among these, the air spring may adjust a vehicle height and a center of gravity depending on running conditions of the vehicle, and may provide a relatively excellent ride quality.

The air spring is of a convolute type, a sleeve type, and the like depending on their forms. In the sleeve type air spring, air is filled into a cylindrical sleeve to support a load and perform a role of cushioning vibration and impact. Such a sleeve is configured such that an outer diameter portion is constrained to the cylinder in order to secure rigidity required for the spring and prevent infinitely expanding.

Japanese Laid-Open Patent Publication No. 2018-112272 (Patent Document 1) discloses the sleeve type air spring in the related art. Herein, FIGS. 1A and 1B illustrate a structure in which a sleeve and a cylinder of the air spring in the related art are coupled to each other. Referring to FIGS. 1A and 1B, in Patent Document 1, ring-shaped members 51 and 52 are welded to a sleeve D made of the same material as those of the ring-shaped members 51 and 52, and the ring-shaped members 51 and 52 are fitted into and fastened to a frame 43 of a cylinder 4. In such a structure in the related art, when air is filled in the sleeve D, the frame 43 is firmly fitted between the ring-shaped members 51 and 52 (see FIG. 1B). However, before the air is filled in the sleeve D, the frame 43 is loosely fitted into the ring-shaped members 51 and 52 (see FIG. 1A).

As described above, in the sleeve type air spring in the related art, the sleeve and the cylinder may not be stably fastened to each other. In addition, in the related art, the ring-shaped members are formed on the sleeve by welding, which may reduce the manufacturing property.

### DOCUMENT IN RELATED ART

### Patent Document

Patent Document 1: Japanese Laid-Open Patent Publication No. 2018-112272 (published on Jul. 19, 2018)

The present disclosure was made to solve the above-mentioned matters, and the present disclosure is for the purpose of providing an air spring assembly capable of enhancing a coupling force between a sleeve and a cylinder.

Further, the present disclosure is for the purpose of providing an air spring assembly capable of enhancing the manufacturing property and assembly tack thereof.

Representative configurations of the present disclosure to achieve the above matters are described below.

According to an example embodiment of the present disclosure, there is provided an air spring assembly used in a vehicle. The air spring assembly according to an example embodiment of the present disclosure may include: a sleeve having a space capable of filling air therein and including an upper opening and a lower opening formed in an upper portion and a lower portion of the sleeve, respectively; an upper cap connected to the upper portion of the sleeve and configured to close the upper opening of the sleeve; a piston connected to the lower portion of the sleeve and configured to close the lower opening of the sleeve; and a cylinder coupled to the sleeve and configured to enclose the sleeve. According to an example embodiment of the present disclosure, a first fixing protrusion may be formed on at least a portion of an outer peripheral surface of the sleeve, a first fixing groove may be formed in at least a portion of an inner peripheral surface of the cylinder, and the first fixing projection may be inserted into and coupled to the first fixing groove.

In an aspect, the first fixing protrusion may be formed in a ring shape along a circumferential direction on the outer peripheral surface of the sleeve, and the first fixing groove may be formed in a ring shape along the circumferential direction in the inner peripheral surface of the cylinder.

In an aspect, the first fixing protrusion may be inserted into and coupled to the first fixing groove by press-fitting the sleeve into the cylinder.

In an aspect, an outer diameter of the sleeve at a portion where the first fixing protrusion of the sleeve is formed may be larger than or equal to an inner diameter of the cylinder at a portion where the first fixing groove of the cylinder is formed.

The air spring assembly according to an example embodiment of the present disclosure may further include a dust cover configured to enclose the cylinder. According to an example embodiment of the present disclosure, a second fixing protrusion may be formed on at least a portion of an outer peripheral surface of the cylinder, and a second fixing groove may be formed in at least a portion of an inner peripheral surface of the dust cover.

In an aspect, the second fixing protrusion may be inserted into and coupled to the second fixing groove.

In an aspect, the second fixing protrusion may be formed in a ring shape along a circumferential direction on the outer peripheral surface of the cylinder, and the second fixing groove may be formed in a ring shape along the circumferential direction in an outer peripheral surface of the dust cover.

In an aspect, the second fixing protrusion may be inserted into and coupled to the second fixing groove by press-fitting the cylinder to the dust cover.

According to an example embodiment of the present disclosure, an outer diameter of the cylinder at a portion where the second fixing protrusion of the cylinder is formed may be formed larger than or equal to an inner diameter of the dust cover at a portion where the second fixing groove of the dust cover is formed.

In an aspect, the first fixing groove and the second fixing protrusion may be formed at positions corresponding to each other.

In an aspect, the first fixing groove and the second fixing protrusion may be formed to have a same shape.

Further, the air spring assembly according to the present disclosure may further include other additional configurations without departing from the technical sprit of the present disclosure.

According to the present disclosure, it is possible to enhance a coupling force between a sleeve and a cylinder by using a coupling structure between the sleeve and the cylinder. Further, it is possible to enhance a coupling force between the cylinder and a dust cover by using a coupling structure between the cylinder and the dust cover.

Further, according to the present disclosure, it is possible to secure an excellent coupling force by a press-fitting process through a simple coupling structure, thereby enhancing the manufacturing property and assembly task.

### BRIEF DESCRIPTION OF THE DRAWINGS

FIGS. 1A and 1B illustrate a structure in which a cylinder and a sleeve of an air spring are coupled to each other in the related art.

FIG. 2 exemplarily illustrates an air suspension including an air spring assembly according to an example embodiment of the present disclosure.

FIG. 3 exemplarily illustrates a cross-sectional structure of the air spring assembly according to an example embodiment of the present disclosure.

FIG. 4 illustrates an enlarged view of a portion A in FIG. 3.

FIGS. 5A and 5B exemplarily illustrate a structure in which a sleeve and a cylinder are coupled to each other in the air spring assembly according to an example embodiment of the present disclosure.

FIGS. 6A and 6B exemplarily illustrate a structure in which the cylinder and a dust cover are coupled to each other in the air spring assembly according to an example embodiment of the present disclosure.

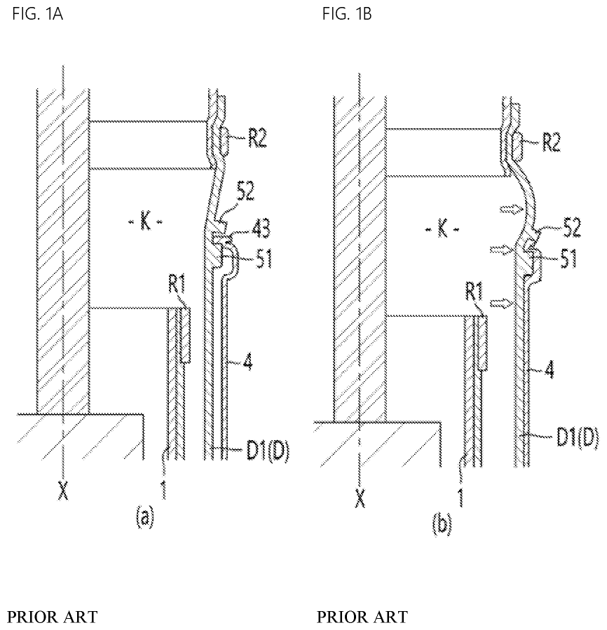

### DETAILED DESCRIPTION

Example embodiments of the present disclosure described below are exemplified for the purpose of describing the technical spirit of the present disclosure. The scope of the claims according to the present disclosure is not limited to the example embodiments described below or to the detailed descriptions of these example embodiments.

Unless otherwise defined, all technical and scientific terms used herein have the same meaning commonly understood by those skilled in the art to which the present disclosure pertains. All terms used herein are selected for the purpose of more clearly describing the present disclosure and not limiting the scope of the present disclosure defined by appended claims.

Unless the phrase or sentence clearly indicates otherwise, terms “comprising” “including” “having” and the like used herein should be construed as open-ended terms encompassing the possibility of including other example embodiments.

The singular form described herein may include the plural form unless the context clearly dictates otherwise, and this is equally applied to the singular form set forth in the claims.

Throughout the present specification, when a constituent element is referred to as being “positioned” at or “formed” on one side of another constituent element, the constituent element may be in direct contact with or directly formed on the one side of another constituent element, or may be positioned at or formed on another constituent element by intervening yet another constituent element therebetween.

Hereinafter, example embodiments of the present disclosure will be described in detail with reference to the accompanying drawings at such an extent that they may be readily practiced by those ordinary skilled in the art. In the accompanying drawings, the same reference numerals are assigned to the same or corresponding components. Further, in the following descriptions of the example embodiments, duplicate descriptions of the same or corresponding constituent elements may be omitted. However, even though a description of a constituent element is omitted, such a constituent element is not intended to be excluded in any example embodiment.

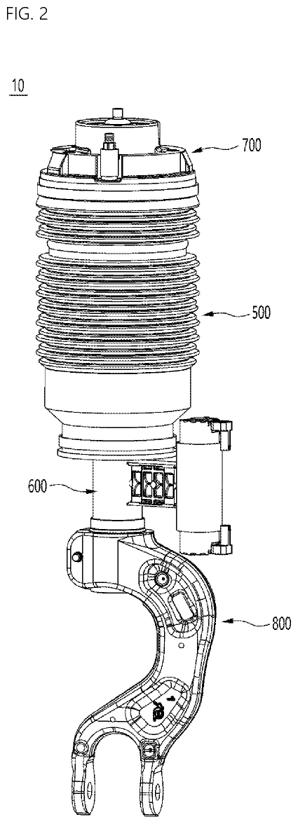

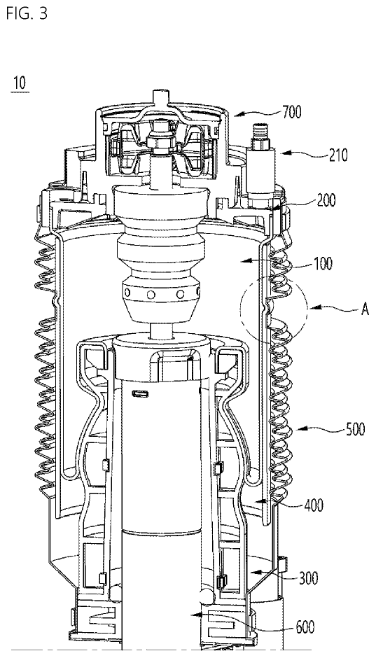

FIG. 2 exemplarily illustrates a suspension including an air spring assembly according to an example embodiment of the present disclosure, and FIG. 3 exemplarily illustrates a cross-sectional structure of the air spring assembly according to an example embodiment of the present disclosure.

Referring to FIGS. 2 and 3, an air spring assembly 10 according to an example embodiment of the present disclosure may include a sleeve 100, an upper cap 200, a piston 300, a cylinder 400 and a dust cover 500, and may constitute an air suspension together with a damper 600, a top mount 700, a suspension arm 800 and the like.

According to an example embodiment of the present disclosure, the sleeve 100 may be kept in a predetermined pressure in a state in which air is filled in the interior of the sleeve 100 so as to play a role of maintaining a required vehicle height and alleviating vibration and impact. In an example embodiment, the sleeve 100 may be formed in an approximately cylindrical shape and may have a space capable of filling air therein.

Further, in an example embodiment, the sleeve 100 may have an upper portion and a lower portion which are open. That is, the upper portion and the lower portion of the sleeve 100 may have an upper opening and a lower opening, respectively. An upper cap 200 and a piston 300 may be disposed at the upper opening and the lower opening of the sleeve 100, respectively. Through the upper cap 200 and the piston 300, the sleeve 100 may be kept airtight.

According to an example embodiment of the present disclosure, the upper cap 200 may be disposed on upper end of the sleeve 100 to close the upper end of the sleeve 100. That is, the upper cap 200 may be connected to the upper portion of the sleeve 100 to close the upper opening of the sleeve 100.

In an example embodiment, an air port 210 may be formed on the upper cap 200. Through the air port 210, air may be filled into or withdrawn from the inner space of the sleeve 100 to adjust the pressure.

According to an example embodiment of the present disclosure, the piston 300 may be disposed at the lower portion of the sleeve 100 to close the lower end of the sleeve 100. That is, the piston 300 may be connected to the lower portion of the sleeve 100 to close the lower opening of the sleeve 100.

In an example embodiment, the piston 300 may be assembled with the sleeve 100 while being disposed to be inserted into the lower portion of the sleeve 100. For example, a portion of an upper end of the piston 300 may be assembled with the sleeve 100 while being be enclosed by the sleeve 100.

In an example embodiment, the piston 300 may be coupled to the damper 600 described below and move up and down together with the damper 600. For example, a hollow is formed in the piston 300 and the damper 600 passes through and placed in the hollow. In this way, the piston 300 and the damper 600 may be coupled to each other.

According to an example embodiment of the present disclosure, the cylinder 400 may play a role of securing rigidity required for the sleeve 100 and limiting the expansion of the sleeve 100. For this purpose, the cylinder 400 may be configured to enclose the sleeve 100.

In an example embodiment, the cylinder 400 may be formed in an approximately cylindrical shape like the sleeve 100 and may be disposed to enclose the sleeve 100 from the outside.

On the other hand, in the related art described above, the coupling force between the sleeve and the cylinder may vary depending on a degree to which the air is filled into the sleeve. When the air is not sufficiently filled into the sleeve, the coupling force may be reduced. In addition, since the ring-shaped members are formed on the sleeve by a separate welding process to couple the sleeve and the cylinder, the manufacturing property may be reduced.

The air spring assembly 10 according to an example embodiment of the present disclosure has the structure in which the sleeve 100 and the cylinder 400 are coupled and fixed to each other with good manufacturing property and assembly task. In an example embodiment, a first fixing protrusion 110 may be formed on at least a portion of an outer peripheral surface of the sleeve 100, and a first fixing groove 410 may be formed on at least a portion of an inner peripheral surface of the cylinder 400. With this configuration, the sleeve 100 and the cylinder 400 may be fastened and fixed to each other.

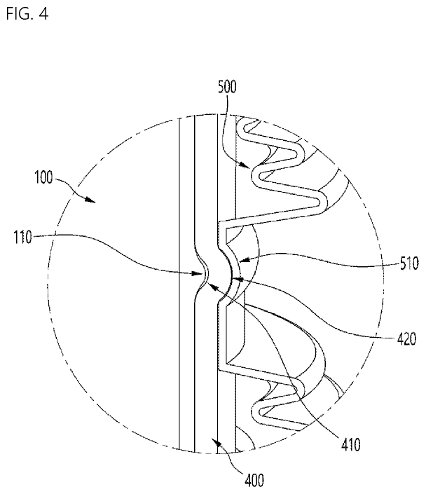

FIG. 4 is an enlarged view of a portion A in FIG. 3. Referring to FIG. 4, the first fixing protrusion 110 is formed on the outer peripheral surface of the sleeve 100, and the first fixing groove 410 may be formed on the inner peripheral surface of the cylinder 400. Further, the first fixing protrusion 110 of the sleeve 100 and the first fixing groove 410 of the cylinder 400 may be formed at positions corresponding to each other and may be identical in size and shape to each other. With this configuration, when the sleeve 100 and the cylinder 400 are coupled to each other, the first fixing protrusion 110 may be inserted into and fixed to the first fixing groove 410.

In an example embodiment, an outer diameter of the sleeve 100 at a portion where the first fixing protrusion 110 of the sleeve 100 is formed may be larger than or equal to an inner diameter of the cylinder 400 at a portion where the first fixing groove 410 of the cylinder 400 is formed. With this configuration, the first fixing protrusion 110 may be inserted into and fixed to the first fixing groove 410 while the sleeve 100 is press-fitted into the cylinder 400.

According to an example embodiment of the present disclosure, the first fixing protrusion 110 of the sleeve 100 may be formed in a ring shape along a circumferential direction on the outer peripheral surface of the sleeve 100. Further, the first fixing groove 410 of the cylinder 400 may be formed as a ring-shaped recess along the circumferential direction in the inner peripheral surface of the cylinder 400.

However, the present disclosure is not limited to the example embodiment described above. The first fixing protrusion 110 of the sleeve 100 and the first fixing groove 410 of the cylinder 400 may be formed in different shapes. For example, the first fixing protrusion 110 of the sleeve 100 may include a plurality of protrusions spaced apart from each other along in the circumferential direction on the outer peripheral surface of the sleeve 100, and the first fixing groove 410 of the cylinder 400 may include a plurality of grooves spaced apart from each other along the circumferential direction in the inner peripheral surface of the cylinder 400. Alternatively, the first fixing protrusion 110 of the sleeve 100 may be one protrusion formed on the outer peripheral surface of the sleeve 100, and the first fixing groove 410 of the cylinder 400 may be one groove formed in the inner peripheral surface of the cylinder 400. In each case, the first fixing protrusion 110 of the sleeve 100 and the first fixing groove 410 of the cylinder 400 may be formed to have shapes and sizes corresponding to each other at positions corresponding to each other so that the first fixing protrusion 110 is inserted into and fixed to the first fixing groove 410.

According to an example embodiment of the present disclosure, the dust cover 500 may serve to protect constituent parts of the air spring assembly 10 from dusts, foreign substances or the like. Referring back to FIGS. 2 and 3, in an example embodiment, the dust cover 500 may be formed in an approximately cylindrical shape and may be placed in a form that fully encloses the piston 300 and the cylinder 400. Wrinkles may be formed on an outer surface of the dust cover 500 to achieve an anti-vibration effect.

The air spring assembly 10 according to an example embodiment of the present disclosure may further have a structure for firmly coupling the dust cover 500 to the cylinder 400. In an example embodiment, a second fixing protrusion 420 may be formed on at least a portion of the outer peripheral surface of the cylinder 400, and a second fixing groove 510 may be formed in at least a portion of an inner peripheral surface of the dust cover 500. With this configuration, the cylinder 400 and the dust cover 500 may be fastened and fixed to each other.

Referring to FIG. 4, the second fixing protrusion 420 is formed on the outer peripheral surface of the cylinder 400, and the second fixing groove 510 is formed in the inner peripheral surface of the dust cover 500. The second fixing protrusion 420 of the cylinder 400 and the second fixing groove 510 of the dust cover 500 may be formed at positions corresponding to each other and may be identical in size and shape to each other. With this configuration, when the cylinder 400 and the dust cover 500 are coupled to each other, the second fixing protrusion 420 may be inserted into and fixed to the second fixing groove 510.

In an example embodiment, an outer diameter of the cylinder 400 at a portion where the second fixing protrusion 420 of the cylinder 400 is formed may be larger than or equal to an inner diameter of the dust cover 500 at a portion where the second fixing groove 510 of the dust cover 500 is formed. With this configuration, the second fixing protrusion 420 may be inserted into and fixed to the second fixing groove 510 while the cylinder 400 is press-fitted into the dust cover 500.

According to an example embodiment of the present disclosure, the second fixing protrusion 420 of the cylinder 400 may be formed in a ring shape along the circumferential direction on the outer peripheral surface of the cylinder 400. Further, the second fixing groove 510 of the dust cover 500 may be formed as a ring-shaped recess along the circumferential direction in the inner peripheral surface of the dust cover 500.

However, the present disclosure is not limited to the example embodiment described above. The second fixing protrusion 420 of the cylinder 400 and the second fixing groove 510 of the dust cover 500 may be formed in different shapes. For example, the second fixing protrusion 420 of the cylinder 400 may include a plurality of protrusions spaced apart from each other along the circumferential direction on the outer peripheral surface of the cylinder 400, and the second fixing groove 510 of the dust cover 500 may include a plurality of grooves spaced apart from each other along the circumferential direction in the inner peripheral surface of the dust cover 500. Alternatively, the second fixing protrusion 420 of the cylinder 400 may be one protrusion formed on the outer peripheral surface of the cylinder 400, and the second fixing groove 510 of the dust cover 500 may be one groove formed in the inner peripheral surface of the dust cover 500. In each case, the second fixing protrusion 420 of the cylinder 400 and the second fixing groove 510 of the dust cover 500 may be formed to have sizes corresponding to each other at positions corresponding to each other so that the second fixing protrusion 420 is inserted into and fixed to the second fixing groove 510.

According to an example embodiment of the present disclosure, the first fixing groove 410 and the second fixing protrusion 420 of the cylinder 400 may be formed at positions corresponding to each other. Referring to FIG. 4, the second fixing protrusion 420 may be formed on the outer peripheral surface corresponding to the position of the inner peripheral surface on which the first fixing groove 410 of the cylinder 400 is formed. Accordingly, the first fixing protrusion 110 of the sleeve 100 may be inserted into and coupled to the first fixing groove 410 of the cylinder 400, and at the same time, the second fixing protrusion 420 of the cylinder 400 may be inserted into and coupled to the second fixing groove 510 of the dust cover 500. By inserting and fastening the protrusions into and to the grooves at the corresponding positions in this way, the sleeve 100, the cylinder 400, and the dust cover 500 may be further firmly fixed to each another. Further, the first fixing groove 410 and the second fixing protrusion 420 of the cylinder 400 are formed by a single process, which makes it possible to secure the good manufacturing property.

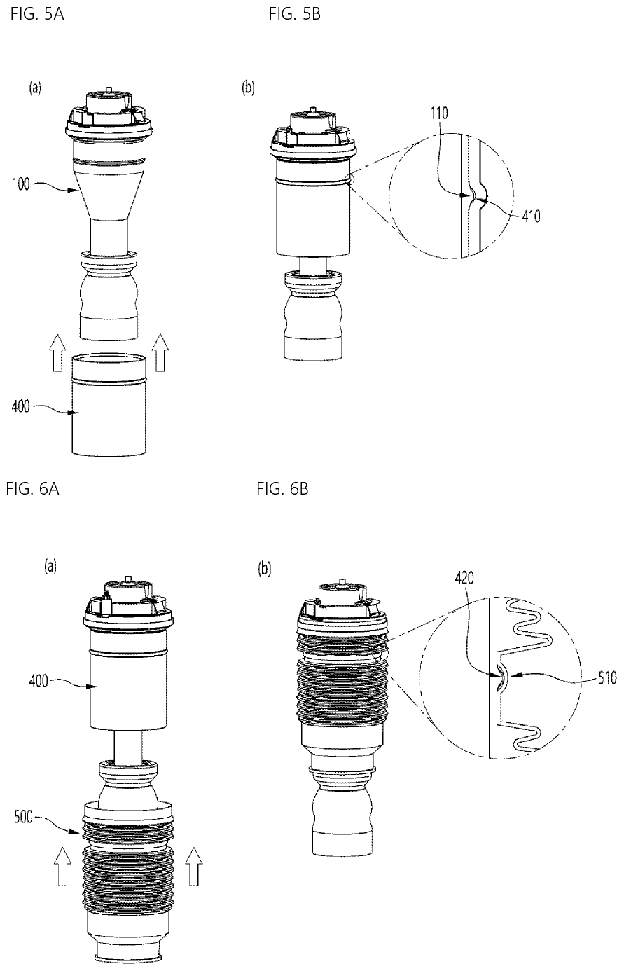

FIGS. 5A and 5B exemplarily illustrate a structure in which the sleeve and the cylinder are coupled to each other in the air spring assembly according to an example embodiment of the present disclosure, and FIGS. 6A and 6B exemplarily illustrate a structure in which the cylinder and the dust cover are coupled to each other in the air spring assembly according to an example embodiment of the present disclosure.

Referring to FIGS. 5A and 5B, the sleeve 100 and the cylinder 400 may be fastened to each other by a press-fitting process (see FIG. 5A). After the press-fitting process, the first fixing protrusion 110 and the first fixing groove 410 may be fixed stably to each other based on the fastening structure according to an example embodiment of the present disclosure (see FIG. 5B).

Referring to FIGS. 6A and 6B, the cylinder 400 and the dust cover 500 may also be fastened by the press-fitting process (see FIG. 6A). After the press-fitting process, the second fixing protrusion 420 and the second fixing groove 510 may be fixed stably to each other based on the fastening structure according to an example embodiment of the present disclosure (see FIG. 6B).

As described above, according to an example embodiment of the present disclosure, the sleeve 100, the cylinder 400, and the dust cover 500 may be fastened to each another by the press-fitting process, which makes it possible to secure the good coupling force and maintain such a stable fixed state while significantly enhancing the manufacturing property and assembly task.

According to an example embodiment of the present disclosure, the damper 600 may be coupled to the piston 300. In an example embodiment, the damper 600 may include a cylinder and a piston rod disposed inside the cylinder. Fluid may be filled in the cylinder to generate a damping force when the piston rod reciprocates.

In an example embodiment, the damper 600 may be disposed to pass through the hollow of the piston 300. The damper 600 and the piston 300 may be configured to integrally move up and down while being coupled to each other. In an example embodiment, a bearing, for example, a thrust bearing, may be disposed at a place where the damper 600 and the piston 300 are connected to each other. The piston 300 may rotate relative to the damper 600 as the bearing is disposed at the place where the damper 600 and the piston 300 are connected to each other. With this configuration, even if a torsional force or a torsional moment is applied to the air spring assembly 10, it is possible to prevent the generation of damage to parts connected to the air spring assembly 10.

According to an example embodiment of the present disclosure, the suspension arm 800 may be connected to a lower portion of the damper 600 so as to connect the air spring assembly 10 to the vehicle shaft or a wheel.

According to an example embodiment of the present disclosure, the top mount 700 may be installed on the upper cap 200 to play a role of coupling and securing the air spring assembly 10 to the vehicle body. In an example embodiment, a bearing, for example, a thrust bearing, may be disposed at a place where the top mount 700 and the upper cap 200 are connected to each other. The upper cap 200 may rotate relative to the top mount 700 as the bearing is disposed at the place where the top mount 700 and the upper cap 200 are connected to each other. With this configuration, even if a torsional force or a torsional moment is applied to the air spring assembly 10, it is possible to prevent the generation of damage to parts connected to the air spring assembly 10.

Although the present disclosure has been described above in terms of specific items such as detailed constituent elements as well as the limited embodiments and the drawings, they are merely provided to help more general understanding of the present disclosure, and the present disclosure is not limited to the above example embodiments. Various modifications and changes could have been realized by those skilled in the art to which the present disclosure pertains from the above description.

Therefore, the spirit of the present disclosure need not to be limited to the above-described example embodiments, and in addition to the appended claims to be described below, and all ranges equivalent to or changed from these claims need to be said to belong to the scope and spirit of the present disclosure.

### EXPLANATION OF REFERENCE NUMERALS

10: Air spring assembly
100: Sleeve
110: First fixing protrusion
200: Upper cap
210: Air port
300: Piston
400: Cylinder
410: First fixing groove
420: Second fixing protrusion
500: Dust cover
510: Second fixing groove
600: Damper
700: Top mount
800: Suspension arm

1. An air spring assembly for a vehicle, the air spring assembly comprising:
a sleeve having a space capable of filling air therein and including an upper opening and a lower opening formed in an upper portion and a lower portion of the sleeve, respectively;
an upper cap connected to the upper portion of the sleeve and configured to close the upper opening of the sleeve;
a piston connected to the lower portion of the sleeve and configured to close the lower opening of the sleeve; and
a cylinder coupled to the sleeve and configured to enclose the sleeve,
wherein a first fixing protrusion is formed on at least a portion of an outer peripheral surface of the sleeve, and a first fixing groove is formed in at least a portion of an inner peripheral surface of the cylinder, and
wherein the first fixing projection is inserted into and coupled to the first fixing groove.

2. The air spring assembly of claim 1, wherein the first fixing protrusion is formed in a ring shape along a circumferential direction on the outer peripheral surface of the sleeve, and wherein the first fixing groove is formed in a ring shape along the circumferential direction in the inner peripheral surface of the cylinder.

3. The air spring assembly of claim 1, wherein the first fixing protrusion is inserted into and coupled to the first fixing groove by press-fitting the sleeve into the cylinder.

4. The air spring assembly of claim 1, wherein an outer diameter of the sleeve at a portion where the first fixing protrusion of the sleeve is formed is larger than or equal to an inner diameter of the cylinder at a portion where the first fixing groove of the cylinder is formed.

5. The air spring assembly of claim 1, further comprising: a dust cover configured to enclose the cylinder,
wherein a second fixing protrusion is formed on at least a portion of an outer peripheral surface of the cylinder, and a second fixing groove is formed in at least a portion of an inner peripheral surface of the dust cover, and
wherein the second fixing protrusion is inserted into and coupled to the second fixing groove.

6. The air spring assembly of claim 5, wherein the second fixing protrusion is formed in a ring shape along a circumferential direction on the outer peripheral surface of the cylinder, and
wherein the second fixing groove is formed in a ring shape along the circumferential direction in the inner peripheral surface of the dust cover.

7. The air spring assembly of claim 5, wherein the second fixing protrusion is inserted into and coupled to the second fixing groove by press-fitting the cylinder to the dust cover.

8. The air spring assembly of claim 5, wherein an outer diameter of the cylinder at a portion where the second fixing protrusion of the cylinder is formed is formed larger than or equal to an inner diameter of the dust cover at a portion where the second fixing groove of the dust cover is formed.

9. The air spring assembly of claim 5, wherein the first fixing groove and the second fixing protrusion are formed at positions corresponding to each other.

10. The air spring assembly of claim 5, wherein the first fixing groove and the second fixing protrusion are formed to have a same shape.
